(19) United States
(12) Patent Application Publication
(10) Pub. No.: US 2012/0229252 A1
(43) Pub. Date: Sep. 13, 2012

(54) METHOD FOR OPERATING A HOUSEHOLD APPLIANCE

(75) Inventor: Ralf Ruether, Ahaus (DE)

(73) Assignee: MIELE & CIE. KG, Guetersloh (DE)

(21) Appl. No.: 13/413,823

(22) Filed: Mar. 7, 2012

(30) Foreign Application Priority Data
Mar. 9, 2011 (DE) 10 2011 001 168.4

(51) Int. Cl. G08B 29/00

(52) U.S. Cl. 340/5.51

(57) ABSTRACT

A method of operating a household appliance that has a knock sensor and an analyzer unit includes detecting an acoustic knocking signal input by a user with the knock sensor. The analyzer unit analyzes the detected acoustic knocking signal so as to initiate a first action in response to identification of a first predeterminable signal sequence and a second action in response to identification of a second predeterminable signal sequence.

### CROSS REFERENCE TO RELATED APPLICATIONS

This application claims priority to German Patent Application No. DE 10 2011 001 168.4 filed Mar. 9, 2011, which is hereby incorporated by reference herein in its entirety.

### FIELD

The present invention relates to a method for operating a household appliance, in particular a fully integrated appliance, which may be in the form of an automatic dishwasher and in which a knock sensor detects an acoustic knocking signal input by a user and the detected signal is analyzed by an analyzer unit.

### BACKGROUND

Household appliances, such as automatic dishwashers, and methods for operating such household appliances are per se known in the art and, therefore, need not be specifically described herein.

In the context of the present invention, household appliances are understood to include, in particular, automatic dishwashers, washing machines and dryers. Such household appliances may be in the form of so-called fully integrated appliances; i.e., appliances which are provided with a decorative front panel and/or the like to match a particular line of furniture. Fully integrated appliances are typically handle-free, especially for esthetic reasons. In particular, to open the door of such a household appliance, a door-opening mechanism is provided which may be driven, for example, electrically. It is known in the prior art to use a so-called “knock sensor” for operating such a door-opening mechanism. This knock sensor serves to detect acoustic signal inputs by a user, the detected signal being analyzed by an analyzer unit, whereupon the door-opening mechanism is operated.

Household appliances of the aforedescribed type have proven practical in everyday use. The user may operate the door-opening mechanism by simply knocking on the decorative front panel of the appliance. Thus, the appliance can be opened in a simple manner without conventional door handles or grips.

### SUMMARY

In an embodiment, the present invention provides a method of operating a household appliance. The method includes detecting, by a knock sensor, an acoustic knocking signal input by a user. The detected signal is analyzed by an analyzer unit so as to identify a respective predeterminable signal sequence and initiate a respective action in response thereto, a first action being initiatable in response to an identification of a first predeterminable signal sequence, a second action being initiatable in response to identification of a second predeterminable signal sequence.

### BRIEF DESCRIPTION OF THE DRAWINGS

Exemplary embodiments of the present invention are described in more detail below with reference to the drawing, in which:

FIG. 1 shows a flow chart illustrating a method in accordance with an embodiment of the invention.

### DETAILED DESCRIPTION

In an embodiment the present invention provides a method for operating a household appliance, in particular a fully integrated appliance, in which a knock sensor detects an acoustic knocking signal input by a user and the detected signal is analyzed by an analyzer unit, and in which the analyzer unit initiates a first action in response to the identification of a first predeterminable signal sequence and a second action in response to the identification of a second predeterminable signal sequence.

In accordance with an embodiment of the present invention, the analyzer unit is designed to be capable of distinguishing between predeterminable signal sequences and to initiate a corresponding action based on the detected signal sequence. Such an action may consist, for example, in operating the door-opening mechanism.

The method according to the present invention is advantageous in that, unlike conventional systems, not just one action may be performed by the analyzer unit. Rather, in accordance with embodiments of the present invention, the analyzer unit is designed to be capable of initiating a plurality of different actions, and to do so based on the knocking signal input detected by the knock sensor. The system can be knowledgeable of predeterminable signal sequences which, when detected by the knock sensor, cause the analyzer unit to perform respective predeterminable actions. Thus, the method advantageously has a broader application spectrum as compared to the prior art, which gives the user additional control options, and thus allows more convenient control of the household appliance.

In accordance with one embodiment of the present invention, a possible first action which may be performed by the analyzer unit is to control a signal output device to output a signal. This first action of actuating the signal output device is carried out in response to the knock sensor detecting a first predeterminable signal sequence.

The signal output device may be controlled to output, for example, information about the operating state of the household appliance. Thus, by means of a simple acoustic knocking signal input by a user, it is possible to query information about the operating state of the household appliance which, in the simplest case, may be information about the estimated remaining time of a cycle of operation.

The signal output device used may be, for example, a speaker which outputs acoustic information. Of course, other signal output devices may alternatively be used in place of, or in combination with, a speaker. Other signal output devices may be, for example, optical signal output devices, such as LEDs.

When the analyzer unit identifies a second predeterminable signal sequence, it performs a second action, such as the actuation of a door-opening mechanism. Accordingly, when the knock sensor detects a second predeterminable signal sequence, the analyzer unit does not actuate the signal output device, but rather actuates the door-opening mechanism in response to the detection of the second signal sequence.

In accordance with another embodiment of the present invention, the first predeterminable signal sequence is produced by knocking once and the second predeterminable signal sequence is produced by knocking twice. Thus, a user knocking once causes a first action to be performed, for example, in order to control a signal output device to output a signal. In contrast, when a user knocks twice, this double knocking is detected by the knock sensor as the second predeterminable signal sequence, causing the analyzer unit to perform a second action which is distinguishable from the first action and which may consist, for example, in controlling the door-opening mechanism to open the door.

In accordance with an embodiment of the present invention, the signal output device is used, in particular, to inform the user of the operating state of the household appliance. To this end, the user may be informed, for example, of the particular wash or drying cycle currently being performed by the household appliance, of the estimated remaining cycle time and/or of a possible fault. Suitable signal output devices include audibly and/or visually perceptible signal output devices, such as, for example, speakers and/or light-emitting devices. When a speaker is used, it is possible to output coded tone sequences; i.e., tone sequences which can be associated by a user with a corresponding information content.

The present invention also relates to a household appliance, in particular a fully integrated appliance, which has a knock sensor, an analyzer unit, a signal output unit and a door-opening mechanism, and which is suitable and designed for carrying out the method described above.

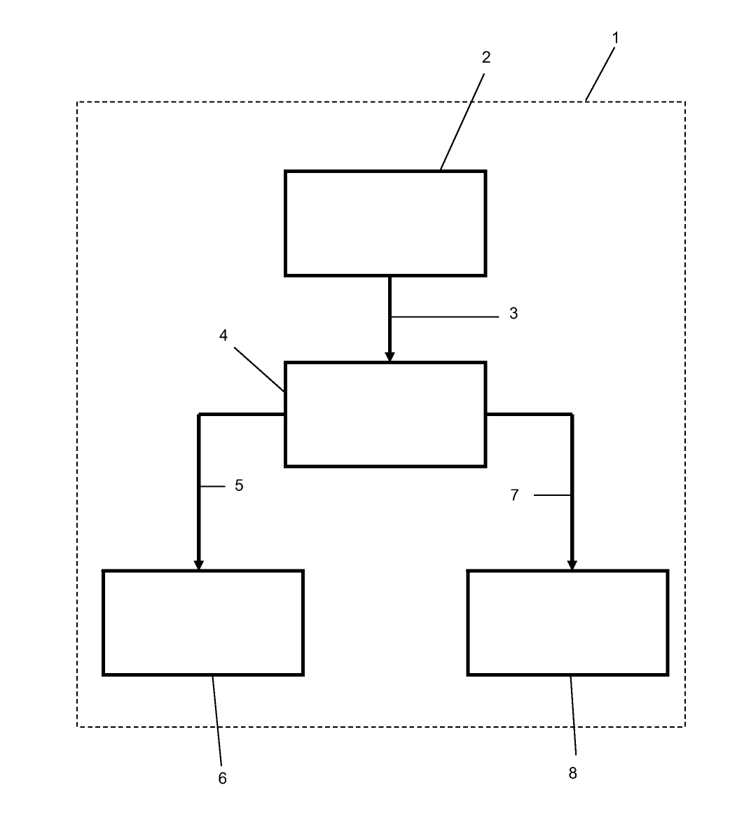

In FIG. 1, a household appliance 1 is shown purely schematically. Household appliance 1 is, for example, an automatic dishwasher. This automatic dishwasher provides a wash chamber for receiving dishes to be cleaned. The wash chamber is accessible through a loading opening which can be closed by a door. In order to open the door, a door-opening mechanism 6 is provided which may be driven, for example, by electric motor means.

Household appliance 1 is provided with a knock sensor 2. Knock sensor 2 serves to detect an acoustic signal input by a user.

Knock sensor 2 is communicatively coupled to an analyzer unit 4, as symbolized in FIG. 1 by arrow 3.

If, during normal operation of household appliance 1, knock sensor 2 detects an acoustic knocking signal input by a user, the detected signal is analyzed by analyzer unit 4.

Household appliance 1 is further provided with the door-opening mechanism 6 mentioned earlier, and with a signal output device 8, which may be in the form of a speaker. Both door-opening mechanism 6 and signal output device 8 are communicatively coupled to analyzer unit 4, as symbolized in FIG. 1 by arrows 5 and 7.

When analyzer unit 4 identifies a first predeterminable signal sequence, it initiates a first action. For example, it may actuate signal output device 8, in particular in accordance with the communication path indicated by arrow 7. In contrast, when analyzer unit 4 identifies a second predeterminable signal sequence, it initiates a second action. For example, it may actuate door-opening mechanism 6, in particular in accordance with the communication path indicated by arrow 5.

The first predeterminable signal sequence may be defined, for example, as a single knock by a user. Once such a single knock is detected by knock sensor 2 and analyzed by analyzer unit 4, analyzer unit 4 actuates signal output device 8.

A second predeterminable signal sequence may be defined as a double knock by a user. Detection of this signal by knock sensor 2 and subsequent analysis thereof by analyzer unit 4 results in an actuation of door-opening mechanism 6.

Thus, by knocking once, the user of household appliance 1 may cause signal output device 8 to output a signal, and by clicking twice he or she may activate door-opening mechanism 6 and thereby open household appliance 1.

Signal output device 8 may be, for example, a speaker. When actuated by analyzer unit 4, the speaker outputs corresponding acoustic signals, for example, in the form of precoded tone sequences. Signal output via signal output device 8 serves preferably to inform the user of household appliance 1 of the operating state of household appliance 1.

While the invention has been particularly shown and described with reference to preferred embodiments thereof, it will be understood by those skilled in the art that various changes in form and details may be made therein without departing from the spirit and scope of the invention.

What is claimed is:

1: A method of operating a household appliance, the method comprising:
detecting, by a knock sensor, an acoustic knocking signal input by a user; and
analyzing, by an analyzer unit, the detected signal so as to identify a respective predeterminable signal sequence and initiate a respective action in response thereto, a first action being initiatable in response to an identification of a first predeterminable signal sequence, a second action being initiatable in response to identification of a second predeterminable signal sequence.

2: The method recited in claim 1, wherein the household appliance is a fully integrated appliance.

3: The method recited in claim 1, wherein the first action corresponding to the identification of the first predeterminable signal includes controlling a signal output device to output a signal.

4: The method recited in claim 3, wherein the signal output device outputs information about an operating state of the household appliance.

5: The method recited in claim 4, wherein the signal output device is a speaker or buzzer configured to output acoustic information.

6: The method recited in claim 5, wherein the acoustic information is about the operating state of the household appliance.

7: The method recited in claim 5, wherein the signal output device is a speaker and is configured to output a coded tone sequence.

8: The method recited in claim 4, wherein the signal output device is an optical signal device.

9: The method recited in claim 8, wherein the optical signal device includes at least one LED.

10: The method recited in claim 1, wherein the second action corresponding to the identification of the second predeterminable signal includes actuating a door-opening mechanism.

11: The method recited in claim 1, wherein the first predeterminable signal sequence corresponds to knocking once.

12: The method recited in claim 1, wherein the second predeterminable signal sequence corresponds to knocking twice.

13: A household appliance comprising:
a knock sensor configured to detect an acoustic knocking signal input by a user;
a signal output unit configured to output an output signal;
a door opening mechanism configured to open a door of the appliance;
an analyzer unit configured to analyze the detected acoustic knocking signal so as to initiate the output of the output signal in response to identification of a first predeterminable signal sequence to initiate the opening of the door in response to identification of a second predeterminable signal sequence.

14: The household appliance recited in claim 13, wherein the household appliance is a fully integrated appliance.

15: The household appliance recited in claim 13, wherein the signal output device is a speaker or buzzer configured to output acoustic information.

16: The household appliance recited in claim 15, wherein the signal output device is a speaker and is configured to output a coded tone sequence.

17: The household appliance recited in claim 13, wherein the signal output device is an optical signal device.

18: The household appliance recited in claim 17, wherein the optical signal device includes at least one LED.
